(19) United States
(12) Patent Application Publication
(10) Pub. No.: US 2006/0190225 A1
(43) Pub. Date: Aug. 24, 2006

(54) Collaborative filtering using random walks of Markov chains

(76) Inventor: Matthew E. Brand, Newton, MA (US)

Correspondence Address: Patent Department;Mitsubishi Electric Research Laboratories, Inc., 201 Broadway, Cambridge, MA, 02139, US

(21) Appl. No.: 11/062,294

(22) Filed: Feb. 18, 2005

(51) Int. Cl. G06F 17/10

(52) U.S. Cl. 703/2

(57) ABSTRACT

A collaborative filtering method first converts a relational database to a graph of nodes connected by edges. The relational database includes consumer attributes, product attributes, and product ratings. Statistics of a Markov chain random walk on the graph are determined. Then, in response to a query state, states of the Markov chain are determined according to the statistics to make a recommendation.

### FIELD OF THE INVENTION

The present invention relates generally to collaborative filtering, and more particularly to collaborative filtering with Markov chains.

### BACKGROUND OF THE INVENTION

A prior art collaborative filtering system typically predicts a consumer's preference for a product based on the consumer's attributes, as well as attributes of other consumers that prefer the product. It should be noted that the term ‘product’ as used herein can mean tangible products, such as goods, as well as services, movies, television programs, books, web pages, sports, entertainment, or anything else that can be ‘rated’. The term ‘consumer’ can mean a user, viewer, reader, and the like. Generally, attributes such as age and gender are associated with consumers, and attributes such as genre, cost or manufacturer are associated with products.

Collaborative filtering can generally be treated as a missing value problem. Product rating tables are generally very sparse. That is, ratings are only available from a very small subset of consumers for any one product in a very large set of possible products. Typically the goal is to predict the missing values and/or rank the unrated items in an ordering that is consistent with an individual consumer's tastes. The system uses these predictions to make recommendations.

Collaborative filtering is described in the following U.S. Pat. No. 6,496,816, Collaborative filtering with mixtures of Bayesian networks; U.S. Pat. No. 6,487,539, Semantic based collaborative filtering; U.S. Pat. No. 6,321,179, System and method for using noisy collaborative filtering to rank and present items; U.S. Pat. No. 6,112,186, Distributed system for facilitating exchange of user information and opinion using automated collaborative filtering; U.S. Pat. No. 6,092,049, Method and apparatus for efficiently recommending items using automated collaborative filtering and feature-guided automated collaborative filtering; U.S. Pat. No. 6,049,777, Computer-implemented collaborative filtering based method for recommending an item to a user; U.S. Pat. No. 6,041,311, Method and apparatus for item recommendation using automated collaborative filtering; and the following U.S. Published Applications: 20040054572, Collaborative filtering; 20030055816, Recommending search terms using collaborative filtering and web spidering; 20020065797, System, method and computer program for automated collaborative filtering of user data.

A broad survey of collaborative filtering from a technical and scientific perspective is provided by Gediminas Adomavicius and Alexander Tuzhilin, “Recommendation technologies: Survey of current methods and possible extensions,” University of Minnisota, USA, MISRC WP 03-29, 2004.

Prior art methods essentially predict a consumer's selection by combining the choices made by other similar consumers. One problem with prior art collaborative filtering systems is that the similarity metric is determined by the system designer, rather than learned from the data.

It is desired that similarity between any two items in the data be informed by all the relationships in the data. This includes relationships both between consumers and between products.

Another problem with prior art collaborative filtering systems is their sensitivity to sampling artifacts in the data. This often produces a bias toward recommending generically popular products rather than obscure but personally appropriate products. It is desired to remove this bias.

### SUMMARY OF THE INVENTION

The invention models consumer's preferences of products as a random walk on a weighted association graph. The graph is derived from a relational database that links consumers, consumer attributes, products and product attributes.

The random walk is described by a Markov chain. The Markov chain amalgamates preferences of a particular consumer over all known consumers. Individual consumers are distinguished by a current state in the Markov chain.

The random walk yields a similarity measure that facilitates information retrieval. The measure of similarity between two states in the chain is a correlation between expected travel times from those two states to states the rest of the chain. The correlation is computed as the cosine of an angle between two vectors that describe the two states of the chain. This measure is highly predictive of future choices made by individual consumers and is useful for recommending and classifying applications. The similarity measure is obtained through a sparse matrix inversion or iterated sparse matrix-vector multiplications.

### BRIEF DESCRIPTION OF THE DRAWINGS

FIG. 1 is a block diagram of a relational database of product ratings used by the invention;

FIG. 2 is a flow diagram of a method for recommending products according to the invention;

FIGS. 3A and 3B are example sparse and dense graphs according to the invention;

FIGS. 4A and 4B are graphs comparing the corresponding classification scores for the graphs in FIGS. 3A and 3B; and

FIG. 5 is a bar graph comparing ratings of average recommendations made according to the invention;

FIG. 6 is a graph comparing recommendations based on statistics;

FIG. 7 is a table of recommendations made according to the invention; and

FIG. 8 is a graph showing interest in movie genre as a condition of age.

### DETAILED DESCRIPTION OF THE PREFERRED EMBODIMENT

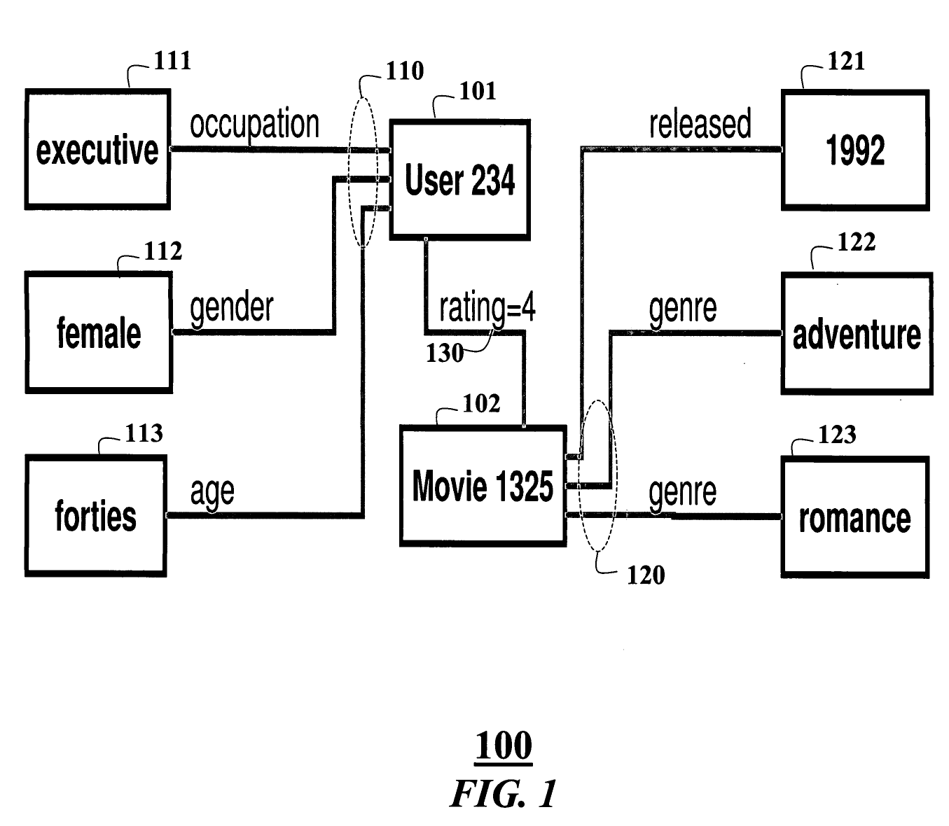

FIG. 1 show a portion of an example relational database 100 of product ratings. A consumer 101 is associated 110 with consumer attributes 111-113. A product 102 is associated 120 with product attributes 121-123. The consumer has given the product a rating 130 of four. It should be understood that the database can store many ratings of products made by many different consumers.

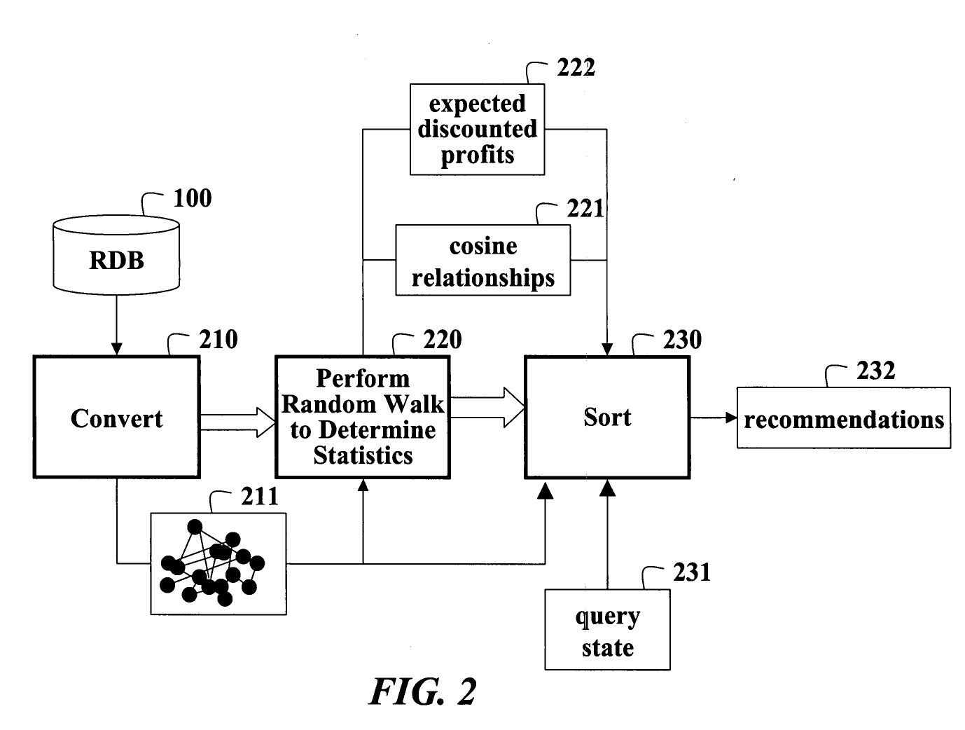

As shown in FIG. 2, the relational database 100 is converted 210 to a graph 211 of nodes connected by directed edges. Statistics are determined 220 by performing a Markov chain random walk on the graph. The random walk produces a Markov chain in which current states of the chain represent individual consumers. The statistics of the states include cosine relationships 221 and expected discounted profits 222. The statistics are sorted 230 in response to a query state 231 in order to make recommendations 232.

The invention provides a collaborative filtering system that makes recommendations based on a random walk 220 of the weighted association graph 211 representing the relational database 100. The associations are between attributes of consumers and attributes of products.

An expected travel time between states of the chain yields a distance metric that has a natural transformation into a similarity measure. The similarity measure is the cosine correlation 221 between the states. This measure is much more predictive of an individual consumer's preferences than classic graph-based dissimilarity measures. As an advantage, the random walk 220 can incorporate contextual information that goes beyond the usual ‘who-liked-what’ of conventional collaborative filtering.

The invention also provides approximation strategies that can operate on very large graphs. The approximations make it practical to determine 220 classically useful statistics, such as expected discounted profits 222 of the states, and can make recommendations 232 that optimize profits.

Statistics of a Markov Chain

A sparse, arbitrary weighted, non-negative matrix specifies edges of the directed association graph 311. The edges represent counts of events, i.e., an edge Wᵢⱼ is the number of times event i is followed by event j. For example, Wᵢⱼ is greater than zero when the user i 101 has rated the movie j 102.

The invention performs a random walk on the directed graph 211 specified by the matrix W. A row-normalized stochastic matrix T=diag(W1)⁻¹W stores transition probabilities of the states of the associated Markov chain, where 1 is a vector of ones.

It is assumed that the Markov chain is irreducible, and has no unreachable or absorbing states. The chain can be asymmetric, and self-transitions model repeated occurrences of events. If the statistics in the matrix W are derived from a fair sample of the collective behavior of a population, then over the short term, the random walk 220 on the graph 211 models the preferences of individual consumers drawn randomly from the population.

Various statistics of the random walk are useful for prediction tasks. A stationary distribution describes relative frequencies of traversing each state in an infinitely long random walk. If the states in the chain represent products used by consumers, then relatively high statistics indicate popular products.

Formally, a stationary distribution satisfies S^{τ}≈S^{τ}T and s^{τ}1=1. If the matrix W is symmetric, then the stationary distribution s=(1^{τ}W)/(1^{τ}W1). Otherwise the distribution can be determined from recurrence sᵢ₊₁^{τ}←sᵢ^{τ}T, s₀=1/N.

Recurrence times: rᵢ=sᵢ⁻¹ describe an expected time between two consecutive visits to the same state. The recurrence times should not be confused with the self-commute time, Cᵢᵢ=0, described below.

An expected hitting time for a random walk from a state i to a ‘hit’ state j can be determined from
A=(I−T−1f^{τ})⁻¹, (1)
where f is any non-zero vector not orthogonal to s, and T is the transpose operator, by
Hᵢⱼ=(Aⱼⱼ−Aᵢⱼ)/sⱼ, and (2)
an expected round-trip commute time is
Cᵢⱼ=Cⱼᵢ=Hᵢⱼ+Hⱼᵢ. (3)

When f=s, the matrix A is the inverse of a fundamental matrix. Two dissimilarity measures Cᵢⱼ and Hᵢⱼ can be used for making the recommendations 232. However, these dissimilarity measures can be dominated by the stationary distribution. This causes the same popular product to be recommended to every consumer, regardless of individual consumer tastes.

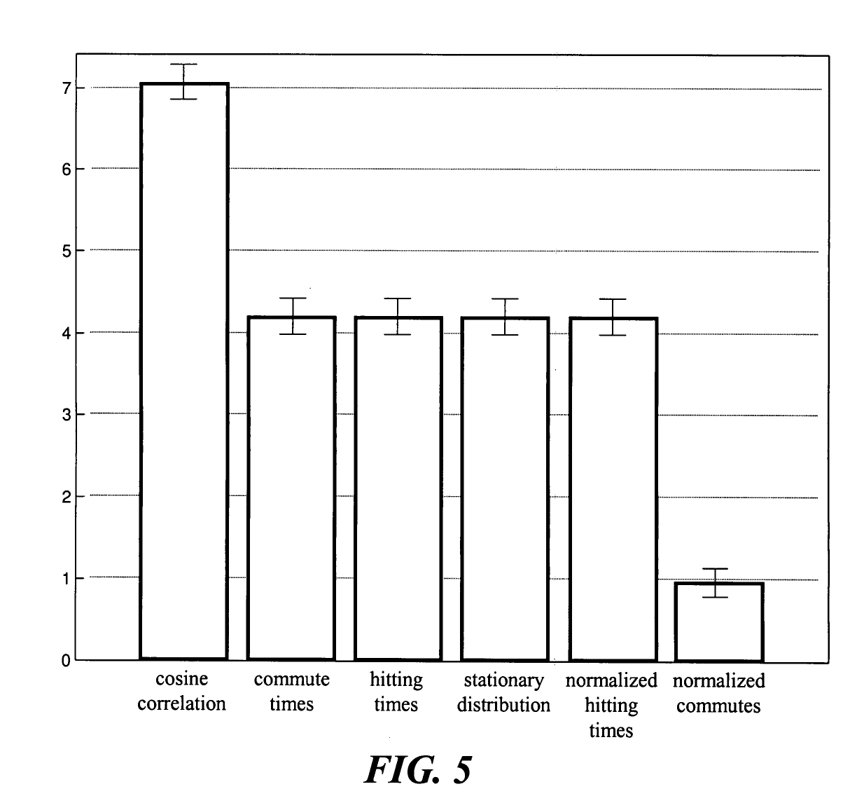

FIG. 5 compares ratings of average recommendations made according to the invention using the above statistics. The cosine correlation is almost twice as effective as all other measures for predicting, e.g., what movies a viewer will see and like.

Random Walk Correlations

The invention connects one of the most useful statistics of information retrieval, a cosine correlation 221, to the random walk. In information retrieval, data items are often represented by vectors. The vectors ‘count’ various attributes of the items, for example, the frequency of particular words in a document. Two items are considered similar when an inner product of their attribute vectors is large. In this example, the document is a sample of a ‘process’ that generates a particular distribution of words. Longer documents increase the sampling of the distribution, resulting in a larger number of words and a larger inner product. However, a larger inner product should not increase the degree of similarity.

To eliminate this “sampling artifact”, information retrieval measures the angle between two attribute vectors. The cosine of this angle is equal to an inner product of normalized vectors. The cosine of the angle also measures an empirical correlation between the two distributions.

The key idea for obtaining the correlations 221 of the random walk is that this enables one to model the long-term behavior of the random walk geometrically:

The square-root of the round-trip commute times satisfy a triangle inequality \sqrt{Cᵢⱼ}+\sqrt{Cⱼₖ}≧\sqrt{Cᵢₖ}, symmetry \sqrt{Cᵢⱼ}=\sqrt{Cⱼᵢ}, and identity \sqrt{Cᵢᵢ}=0. Identifying commute times with squared distances Cᵢⱼ˜∥xᵢ−xⱼ∥² provides a geometric embedding of the Markov chain in Euclidean space, with each state assigned to a point.

In the Euclidean embedding, similar states are nearly co-located with frequently visited states located near the origin. However, as with commute times, the proximity of popular but possibly dissimilar states makes Euclidean distances unsuitable for most applications.

As noted above, the correlation 221 factors out this centrality. The correlation is the cosine of the angle (xᵢ, xⱼ) between the attribute vectors xᵢ, xⱼ of states i and j.

To obtain the cosines of the angles, the matrix of squared distances C is converted to a matrix of inner products P by observing that

$$\begin{matrix}{C}_{i j} = {‖ {x}_{i} - {x}_{j} ‖}^{2} , & ( 4 ) \\ = {x}_{i}^{T} {x}_{i} - {x}_{i}^{T} {x}_{j} - {x}_{j}^{T} {x}_{i} + {x}_{j}^{T} {x}_{j} , & ( 5 ) \\ = {P}_{i i } - {P}_{i j} - {P}_{j i} + {P}_{j j} . & ( 6 )\end{matrix}$$

The row- and column-averages Pᵢᵢ=xᵢ^{τ}xᵢ and Pⱼⱼ=xⱼ^{τ}xⱼ are removed from the matrix C by a double-centering
−2·P=(I−1/N11^{τ})C(I−1/N11^{τ}), (7)
which yields Pᵢⱼ=xᵢ^{τ}xⱼ. Thus, the cosine correlation 211 is then the cosine of the angle

$${θ}_{i j} = \frac{{x}_{i}^{T} {x}_{j}}{‖ {x}_{i} ‖ \cdot ‖ {x}_{j} ‖} = \frac{{x}_{i}^{T} {x}_{j}}{\sqrt{{x}_{i}^{T} {x}_{i}} \cdot \sqrt{{x}_{i}^{T} {x}_{j}}} = \frac{{P}_{i j}}{\sqrt{{P}_{i i } {P}_{j j }}} . \qquad ( 8 )$$

Appendix A describes how to determine the matrix P directly from the sparse matrices T and W, without having to determine the dense matrix C. For the special case of the symmetric, zero-diagonal matrix W, the matrix P simplifies to a pseudo-inverse of the graph Laplacian diag(W1)−W.

The cosine correlation 211 also has a geometric interpretation. If all points are projected onto a unit hyper-sphere to remove the effect of generic popularity and their pair-wise Euclidean distances are denoted by d_{°}ᵢⱼ, then
cos θᵢⱼ=1−(\check{d}ᵢⱼ)²/2. (9)

In this embedding, the correlation of one point to another increases as their sum-squared Euclidean distance decreases. This makes the summed and averaged correlations a geometrically meaningful way to measure similarity between two groups of states.

In large Markov chains, the norm ∥xᵢ∥ is a close approximation, up to scale, of the recurrence time rᵢ=sᵢ⁻¹, which is roughly the inverse “popularity” of a state. Therefore, the cosine correlations 221 can be interpreted as a measure of similarity that decreases artifacts due to an uneven sampling.

For example, if two Web ‘pages’ are very popular, then the expected time to visit either page from any other page is low, and the two pages have a small mutual commute time. However, if the two pages are usually accessed by different people or if the two pages are associated with different sets of attributes, the cosine of the angle between attribute vectors is large, implying a dissimilarity.

Similarly, for a database of movies, the commute time from the horror thriller “Silence of the Lambs” to the children's film “Free Willy” is smaller than the average commute time to either movie, because both movies were very popular. Yet, the angle between their attribute vectors is larger than average because there is little overlap in their audiences.

However, to construct and invert a dense N×N matrix requires on the order of N³ operations, which is clearly impractical for large Markov chains. This is also wasteful because most queries only involve submatrices of the matrix P and the cosine matrix. The Appendix A describes how the submatrices can be estimated directly from the sparse Markov chain parameters.

Recommending and Classifying

To make a recommendation, a query state 221 is selected, and other states of the Markov chain are sorted 230 according to their corresponding cosine correlations 221 to the query state 231. The query state can represent consumer attributes, product attributes, or both consumer and product attributes.

Recommending according to this model is related to a semi-supervised classification problem. There, states are embedded in the Euclidean space as labeled (classified) and unlabelled (unclassified) points. A similarity measure is determined between an unlabelled point and labeled points. Unlike fully supervised classification, the similarity between the unlabelled point and the labeled points is mediated by the distribution of other unlabelled points in the space, which in turn influences the distance metric over the entire data set.

Similarly, in a random walk on the graph 211, the similarity between two states depends on the distribution of all possible paths performed by the random walk of the graph.

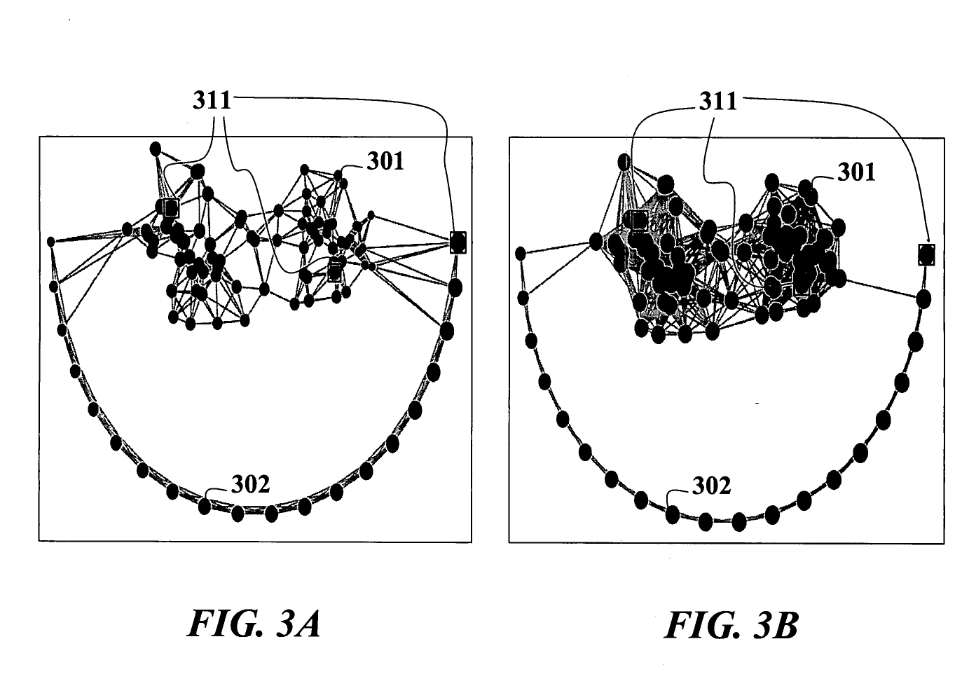

FIGS. 3A and 3B illustrate this. Eighty points 301 are arranged in two Gaussian clusters in a 2D plane, surrounded by an arc of twenty points 302. FIG. 3A is a sparse graph that connects every point to its k nearest neighbors.

FIG. 3B is a dense graph that connects every point to all neighbors within a predetermined distance. Weights for edges are a according to a fast-decaying function of Euclidean distance, e.g., Wᵢⱼ∝ exp(−dᵢⱼ²/2). The size of each vertex dot indicates the magnitude of its classification score. Vertices with a score greater than zero are classified as belonging to the arc.

Although connectivity and edge weights are loosely related to Euclidean distance, similarity is mediated entirely by the graph. Three labeled points 311 in each graph, one on the arc and one on each cluster, represent two classes. The remaining points can be classified according to a similarity measure
(I−αN)⁻¹, with N=diag(W1)^{-1/2}Wdiag(W1)^{-1/2},
which is a normalized combinatorial Laplacian function, and 0<α<1 is predetermined regularization parameter.

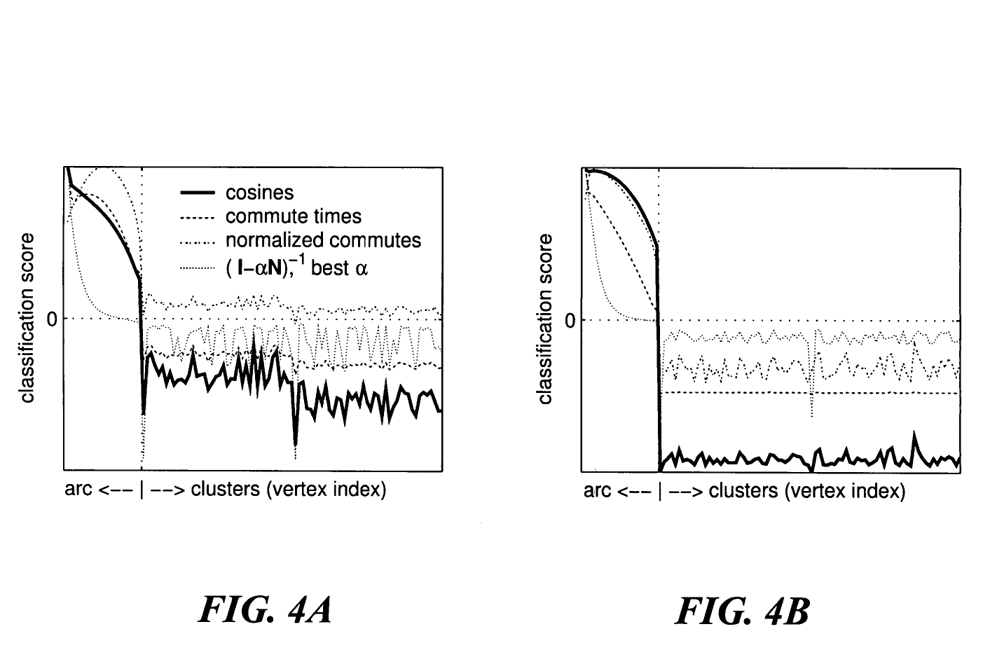

FIGS. 4A and 4B shows how points are classified using the cosine correlations 221 of the random walk 220 on the graphs 211. Classification is performed by summing or averaging correlations to the labeled points. Classification scores, depicted by the size of the graph vertices, are a difference between the recommendation score for two classes.

FIGS. 4A and 4B show the corresponding variations of the classification when criteria for adding edges to the graph changes. The cosine correlations and commute times both perform well, in the sense of giving an intuitively correct classification that is relatively stable as the density of edges in the graph is varied. The cosine relations offer a considerably wider classification margin, and, consequently, the cosine relations provide stability to small changes in the graph.

Normalized commute times, (I−αN)⁻¹, hitting times, reverse hitting times, and their normalized variants classify adequately on dense graphs, but inadequately on sparse graphs. From this example, it is expected that the cosine correlations 221 give consistent recommendations under small variations in the association graph 211.

Expected Profit

While a consumer is interested in finding an interesting product, a vendor would like to recommend profitable products. Assuming the consumer will acquire additional products in the future and that purchase decisions are independent of profit margins, decision theory suggests that an optimal strategy recommends the product (state) with the greatest expected profit, discounted over time. That is, the vendor wants to “nudge” a consumer into a state from which the random walk will pass through highly profitable states, hence, retail strategies such as “loss leaders.” Moreover, these profitable states should be traversed early in the random walk.

A vector of profit or loss, for each state is p ∈ R^{N}, and a discount factor e^{-β}, β>0 determines a time value of future profits. An expected discounted profit 222 νᵢ of an i^{th} state is the averaged profit of every reachable state from the i^{th} state, discounted for the time of arrival. In vector form:
v=p+e^{-β}Tp+e^{-2β}T²p+ . . . . (10)

Using an identity
Σᵢ₌₀^{∞}Xⁱ=(I−X)⁻¹
for matrices of less than unit spectral radius (λₘₐₓ(X)<1), the above series is arranged as a sparse linear system:

$$v = ( {\sum }_{t = 0}^{∞} {ⅇ}^{- β t} {T}^{t} ) p = {( I - {ⅇ}^{- β} T )}^{- 1} p .$$

For example, a most profitable recommendation for a consumer in state i is the state j in the neighborhood of state i that has the largest expected discounted profit:
j=arg max_{j∈N(i)}Tᵢⱼνⱼ.

If the states in the Markov chain represent products that are k steps from a current state, then an appropriate term is
arg max_{j∈N(i)}Tᵢⱼ^{k}νⱼ.

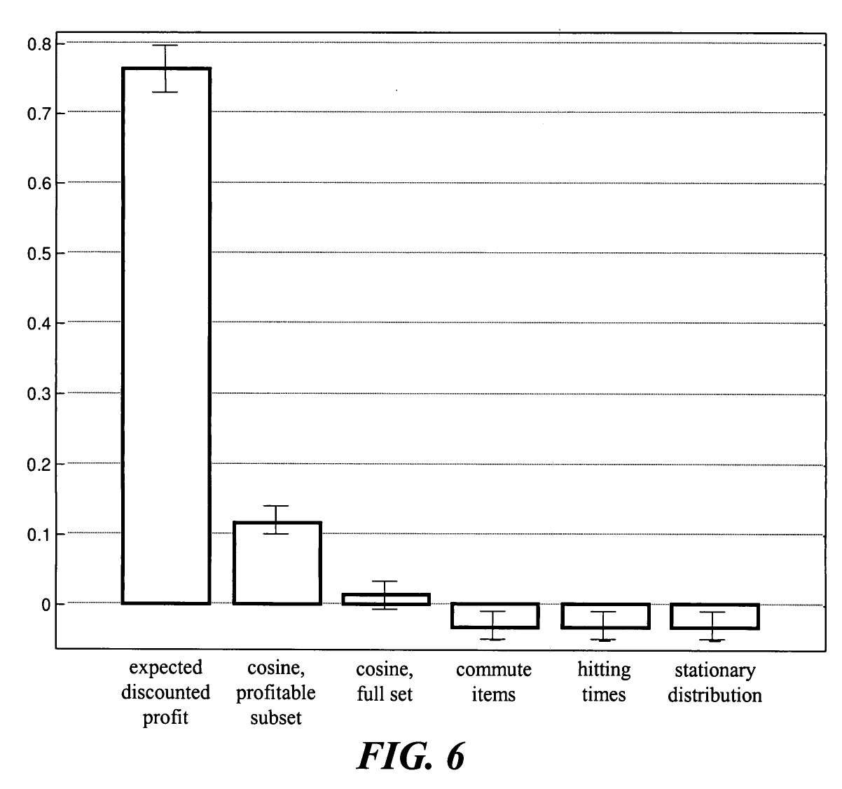

FIG. 6 compares recommendations based on various statistics. Making recommendations that maximize long-term profit is a much more successful strategy than recommending strictly profitable products, and profit-blind recommendations make no profit at all.

Market Analysis

Because the method according to the invention can make recommendations 232 from any state in the Markov chain, it is possible to identify products that are particularly successful with a particular consumer demographic, or consumers that are particularly loyal to specific product categories.

For example, a movie database stores ranks of movies, and the gender and age of consumers, J. Herlocker, J. Konstan, A. Borchers, and J. Riedl, “An algorithmic framework for performing collaborative filtering.” The method according to the invention was applied to the database to determine preferences by gender.

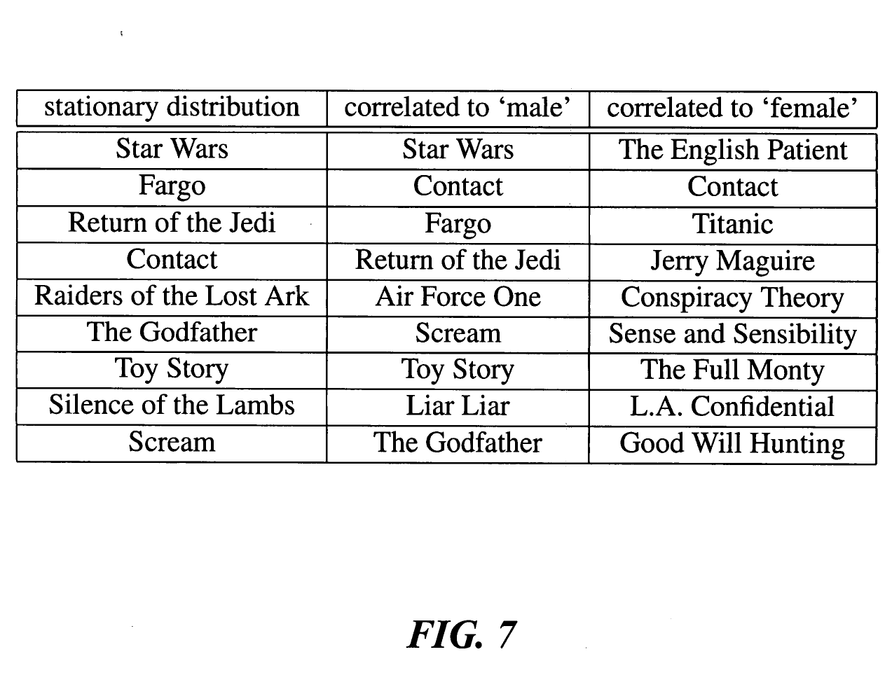

FIG. 7 shows the top ten recommendations for each gender. As shown in FIG. 7, ranking movies by their commute times or expected hitting times from these states turns out to be uninformative, as the ranking is almost identical to the stationary distribution ranking. This is understandable for men because most of the consumers in the database are male. However, ranking by cosine correlation produces two very different lists, with males preferring action and sci-fi movies and females preferring romances and dramas.

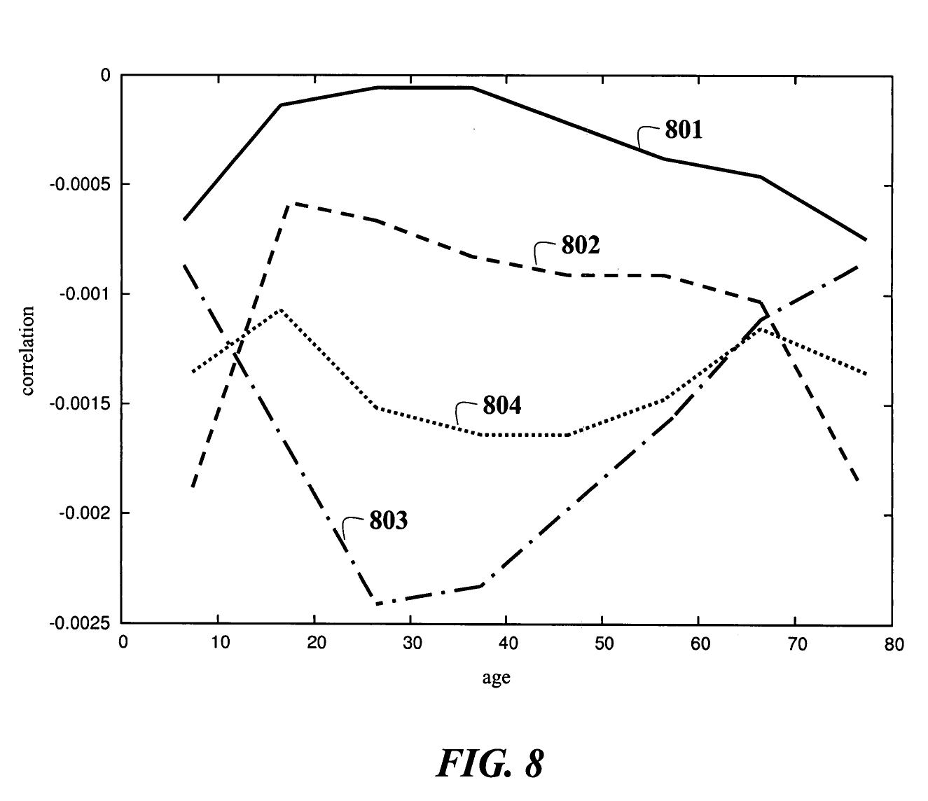

As shown in FIG. 8, the same method can determine which genres are preferentially watched by consumers of particular age groups. FIG. 8 shows that age is indeed weakly predictive of genre preferences. Correlation of age to genre preferences is weak but clearly shows that interest in sci-fi movies 802 peaks in the teens and twenties. Soon after, interest in adventure 801 peaks and interest in drama 803 and film noir 804 begins to climb.

Effect of the Invention

Random walks of association graphs are a natural way to determine affinity relations in a relational database. The random walks provide a way to make use of extensive contextual information, such as demographics and product categories in collaborative filtering applications.

The invention derives a novel measure of similarity, which is the cosine correlation of two states in a random walk of a weighted graph representing the relational database. This measure is highly predictive for recommendation and classification applications.

Correlation-based rankings are more predictive and robust to perturbations of the edge set of the graph than rankings based on commute times, hitting times, and related graph-based dissimilarity measures of the prior art.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

### Appendix A

Implementation Strategies

For chains with N>>10³ states, it is impractical to determine a full matrix of commute times or even a large matrix inversion of the form (I−X)⁻¹∈R^{N×N}. To minimize resource requirements, the fact that most computations have the form (I−X)⁻¹G is exploited, where the matrices X and G are sparse. For many queries, only a subset of the possible states are compared. Because the matrix G is sparse, only a small subset of columns of the inverse of the matrix are necessary. These can be computed via the series expansions

$${( I - X )}^{- 1} = {\sum }_{i = 0}^{∞} {X}^{i} = {\prod }_{i = 0}^{∞} ( I - {X}^{{2}^{i}} ) , \qquad ( 12 )$$

which can be truncated to yield good approximations for fast-mixing sparse Markov chains. In particular, an n-term sum of the additive series can be evaluated via 2 log₂ n sparse matrix multiplies via a multiplicative expansion. For any one column of the inverse this reduces to sparse matrix-vector products.

One problem is that these series only converge for matrices of less than unit spectral radius (λₘₐₓ(X)<1). For inverses that do not conform, the associated series expansions have a divergent component that can be incrementally removed to obtain the numerically correct result. For example, in the case of hitting times, X=T+1s^{τ}, which has spectral radius of two. By expanding the additive series, undesired multiples of 1s^{τ} accumulate quickly in the sum. Instead, an iteration that removes the undesired multiples is constructed as the arise:
A₀←I−1s^{τ} (13)
B₀←T (14)
Aᵢ₊₁←Aᵢ+Bᵢ−1s^{τ} (15)
Bᵢ₊₁←TBᵢ, (16)
which converges, as i approaches infinity, to
Aᵢ←(I−T−1s^{τ})⁻¹+1s^{τ}. (17)
Note that this is easily adapted to compute an arbitrary subset of the columns of Aᵢ and Bᵢ, making it economical to compute submatrices of H. Because sparse chains tend to mix quickly, Bᵢ converges rapidly to a stationary distribution 1s^{τ}, and Aᵢ is a good approximation, even for i<N. A much faster converging recursion for the multiplicative series can be constructed as:
A₀←I−1s^{τ} (18)
B₀←T (19)
Aᵢ₊₁←Aᵢ+AᵢBᵢ (20)
Bᵢ₊₁←B²ᵢ (21)
This converges exponentially faster but requires computation of the entire Bᵢ. In both iterations, one can substitute 1/N for S. This shifts the column averages, which are removed in the final calculation
H←(1diag(Aᵢ)^{τ}−Aᵢ)diag(r). (22)
The recurrence times rᵢ=sᵢ⁻¹ can be obtained from the converged Bᵢ=1s^{τ}. It is possible to compute the inner product matrix P directly from the Markov chain parameters. The identity
P=(Q+Q^{τ})/2 (23)
with
Q−(1/iN)11^{τ}=(I−T−(i/N)r1^{τ})⁻¹diag(r)=(diag(s)−diag(s)T−(i/N)11^{τ})⁻¹, for 0<i<N (24)
can be verified by expansion and substitution. For a submatrix of P, one need only to compute the corresponding columns of Q using appropriate variants of the iterations above.

Once again, if s and r are unknown prior to the iterations, one can make the substitution s→1/N. At convergence, the resulting
A′=Ai−(1/N)11^{τ}, s=1^{τ}Bᵢ/cols(Bᵢ), rᵢ=sᵢ⁻¹
satisfy
A′−(1/N)(A′r−1)s^{τ}=(I−T−(1/N)r1^{τ})⁻¹ (25)
and
Q=A′ diag(r)(I−(1/N)11^{τ}). (26)
However, because the stationary distribution s is not predetermined, the last two equalities require full rows of Aᵢ, which defeats the goal of economically computing submatrices P.

Such partial computations are quite feasible for undirected graphs with no self-loops: When W is symmetric and zero-diagonal, Q in equation (24) simplifies to the Laplacian kernel
Q=P=(1^{τ}W1)·(diag(W1)−W)⁺, (27)
a pseudo-inverse because the Laplacian diag(W1)−W has a null eigenvalue. The Laplacian has a sparse block structure that allows the pseudo-inverse to be computed via smaller singular value decompositions of the blocks, but even this can be prohibitive.

The pseudo-inversion can be avoided entirely by shifting the null eigenvalue to one, inverting via series expansion, and then shifting the eigenvalue back to zero. These operations are collected together in the equality

$$\frac{I}{{1}^{T} W 1} P = D ( {( I - \{ D ( W - \frac{i}{N} {11}^{T} ) D \} )}^{- 1} D - \frac{1}{i N} {11}^{T} , \qquad ( 28 )$$

where
D≈diag(W1)^{-1/2} and 0<i.

By construction, the term in braces {·} has a spectral radius<1 for i≦1. Thus, any subset of columns of the inverse, and of P, can be computed via straightforward additive iteration.

One advantage of couching these calculations in terms of sparse matrix inversion is that new data, such as a series of purchases by a customer, can be incorporated into the model via lightweight computations using the Sherman-Woodbury-Morrison formula for low-rank updates of the inverse.

I claim:

1. A computer implemented method for collaborative filtering, comprising:
converting a relational database to a graph of nodes connected by edges, the relational database including consumer attributes, product attributes, and product ratings;
determining statistics of a Markov chain random walk on the graph; and
sorting, in response to a query state, states of the Markov chain according to the statistics to make a recommendation.

2. The method of claim 1, in which a current state of the Markov chain distinguishes an individual consumer.

3. The method of claim 1, in which the statistics include the correlations between states in the random walk, and further comprising:
measuring a degree of similarity of two states according to expected travel times from the two states to all other states.

4. The method of claim 3, in which the graph is a weighted association graph, and an expected travel time between states of the Markov chain yields a distance metric corresponding to a dissimilarity measure between the two states.

5. The method of claim 3, in which a non-negative matrix specifies the edges and associated weights, and a larger weight indicates a greater affinity between a particular user and a particular product.

6. The method of claim 5, in which a row-normalized stochastic matrix specifies transition probabilities in the random walk.

7. The method of claim 1, in which the statistics include expected discounted profits for recommending the products.

8. The method of claim 1, in which the query state represents consumer attributes.

9. The method of claim 1, in which the query state represents product attributes.

10. The method of claim 1, in which the query state represents consumer attributes and product attributes.

11. A collaborative filtering system, comprising:
a relational database including consumer attributes, product attributes, and product ratings;
a graph of nodes connected by edges derived from the relational database;
statistics of a Markov chain random walk on the graph; and
means for sorting, in response to a query state, states of the Markov chain according to the statistics to make a recommendation
